(19) United States
(12) Patent Application Publication
(10) Pub. No.: US 2019/0364874 A1
(43) Pub. Date: Dec. 5, 2019

(54) Drop-Style Trap Door for Trapping Animals

(71) Applicant: Hufstedler Solutions LLC, West Plains, MO (US)

(72) Inventor: Andrew Joseph Hufstedler, West Plains, MO (US)

(21) Appl. No.: 15/992,869

(22) Filed: May 30, 2018

(51) Int. Cl. A01M 23/00; E05B 65/00; E05D 15/16; E05C 19/08

(52) U.S. Cl. CPC A01M 23/00; E05B 65/0007; E05Y 2900/40; E05C 19/08; E05D 15/165

(57) ABSTRACT

The present disclosure relates to a drop-style trap door for use in connection with trapping an animal. The trap door according to the present disclosure may comprise an outer frame, a gate positioned adjacent to the outer frame and having a plurality of slide tubes capable of vertically translating along the outer frame, and a spring-loaded mechanism coupled to the outer frame for receiving at least one of the plurality of slide tubes and securing the gate in a closed position.

### BACKGROUND

Feral hogs and other invasive wild species cause millions of dollars of damage to land and crops in the United States each year. These destructive animals compete for resources with native wildlife, contaminate water supplies, and transmit disease among livestock, pets and humans.

Various trapping mechanisms have been devised to trap these wild species through the use of nets, cages, and/or corrals. Some of these systems utilize trap doors or gates which may be bulky, expensive to manufacture, or fail to operate due to binding.

### SUMMARY

The present disclosure relates to a drop-style trap door for use in connection with trapping an animal.

In an implementation, the drop-style trap door according to the present disclosure may comprise an outer frame; a gate positioned adjacent to the outer frame and having a plurality of slide tubes capable of vertically translating along the outer frame; and a spring-loaded mechanism coupled to the outer frame for receiving at least one of the plurality of slide tubes and securing the gate in a closed position.

In another implementation, the drop-style trap door according to the present disclosure may comprise an outer frame having parallel vertical sides; a gate having a left side and a right side parallel to and adjacent to the parallel vertical sides of the outer frame, the left side and the right side each having a pair of slide tubes to facilitate vertical translation of the gate along the outer frame; and a spring-loaded mechanism coupled to the outer frame for securing the gate in a closed position.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1 illustrates a front view of a drop-style trap door according to the present disclosure.

FIG. 1a illustrates a top view of a leg member and slide tube of the drop-style trap door according to the present disclosure.

FIG. 2 illustrates a perspective view of the drop-style trap door of FIG. 1 as used in conjunction with a corral-style trapping system.

### DETAILED DESCRIPTION

Due to the increasing populations of invasive wild species such as feral hogs, there is a growing need for trapping devices and mechanisms to assist in controlling the population of these animals. Trapping devices may include box traps, cage traps, and/or corral traps, each of these typically requiring a trap door or gate to enclose the captured animal(s). Conventional trap door mechanisms are either too small (allowing a user to trap only one or two animals at a time), or if larger, are often cumbersome for the user due to size, weight, and/or maintenance requirements.

Some trap doors are designed to fall to closure when triggered. These “drop-door” mechanisms often fall unevenly and bind, thereby preventing the trap door from closing completely and allowing the baited animal to escape. In other instances, even when the drop-door closes completely, the trapped animal is able to root (i.e., by turning the ground with its snout) and effectively lift the gate to escape.

Embodiments of the present disclosure generally relate to a drop-style trap door used in connection with trapping an animal. The drop-style trap door may comprise a plurality of different features and components as described herein.

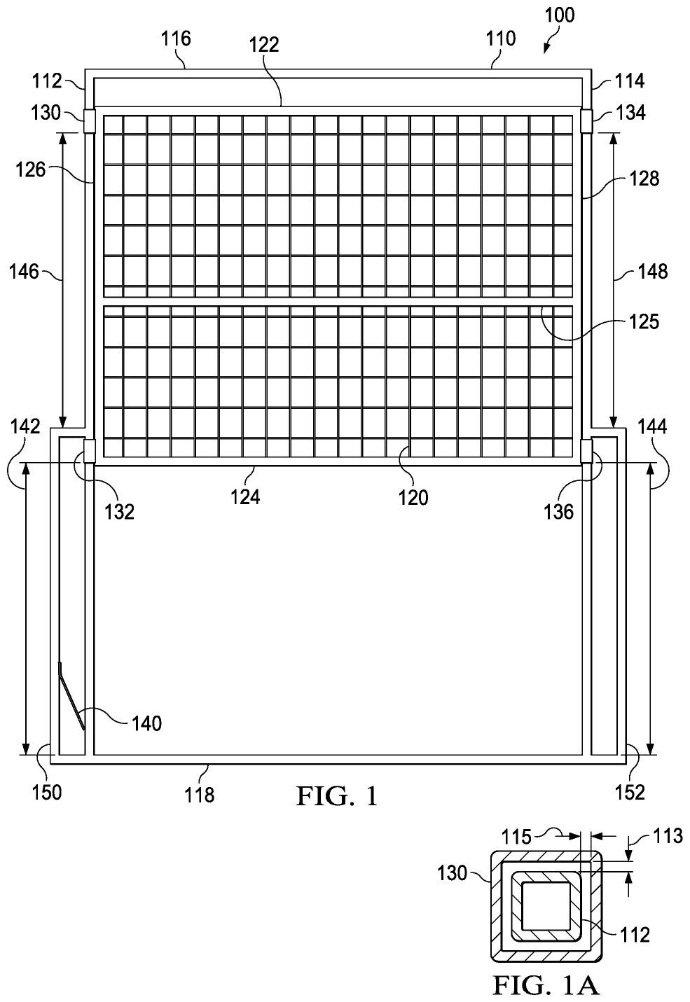

FIG. 1 depicts a drop-style trap door (or drop-style gate) 100 according to the present disclosure. As shown in FIG. 1, drop-style trap door 100 may comprise an outer frame 110, a gate 120, slide tubes 130, 132, 134, and 136, and a spring-loaded mechanism 140.

Outer frame 110 may comprise vertically-parallel leg members 112, 114 connected at the top and bottom by connecting members 116, 118. Leg members 112, 114 and connecting members 116 and 118 may comprise square metal tubing, round metal tubing, metal rods, or any variety of material known in the art. Outer frame 110 may resemble a rectangular shape and may stand approximately 10 feet in height. The size and height of the outer frame may be varied based on user needs and preferences.

Gate 120 may be positioned adjacent to or within the perimeter of outer frame 110 and may comprise a top side 122, a bottom side 124, a left side 126, and a right side 128. The gate 120 may substantially encompass the width of outer frame 110. Gate 120 may further comprise a horizontal cross member 125 appearing slightly lower than the horizontal centerline of gate 120. Horizontal cross member 125 may help maintain integrity of gate 120, as trapped animals may tend to run into the lower half of the gate 120 when the gate 120 is in a closed position.

Gate 120 may further comprise four slide tubes 130, 132, 134, 136 positioned at various corners of the gate 120. For example, as shown in FIG. 1, slide tube 130 may be coupled to the top of the left side 126 of the gate 120; slide tube 132 may be coupled to the bottom of the left side 126 of the gate; slide tube 134 may be coupled to the top of the right side 128 of the gate 120; and slide tube 136 may be coupled to the bottom of the right side 128 of the gate 120. In an implementation, slide tubes 130, 132, 134, 136 may be at least 2 inches in length.

Leg members 112 and 114 of outer frame 110 pass through slide tubes 130, 132, 134, 136, so that gate 120 may vertically translate along the length of the outer frame 110. Due to the size and positioning of the slide tubes 130, 132, 134, 136 on or about the four corners of the gate, the gate is substantially less likely to bind as it drops to a closed position. Gate 120 and slide tubes 130, 132, 134, and 136 may be composed of any variety of material known in the art.

With continued reference to FIG. 1, the vertical length of upper portions 146, 148 of gate 120 may preferably be equal to or greater than the length of lower portions 142, 144 of leg members 112, 114, ensuring that gate 120 will fully close against connecting member 118. As shown in FIG. 1, when the gate 120 is in a fully raised position, upper portion 146 of gate 120 corresponds substantially to the length between slide tube 130 and a point on the gate 120 that is just above the top-most surface of support member 150 (above slide tube 132). Similarly, upper portion 148 of gate 120 corresponds substantially to the length between slide tube 134 and a point just above the top-most surface of support member 152 (above slide tube 136). As further shown in FIG. 1, when the gate 120 is in a fully raised position, lower portion 142 of leg member 112 substantially corresponds to the lower section of leg member 112 from the point directly below the gate 120 to the lower connecting member 118. Likewise, lower portion 144 of leg member 114 substantially corresponds to the lower section of leg member 114 from the point directly below the gate 120 to the lower connecting member 118.

Reference is now made to FIG. 1a, wherein is shown a top view of a slide tube with leg member disposed therein (slide tube 130 and leg member 112 are shown for purposes of example only, and FIG. 1a may be applicable to each of the slide tubes 130, 132, 134, 136 and leg members 112, 114 disclosed). In an implementation, a clearance of 0.125 inches to 0.250 inches may be preferred between leg member 112 and slide tube 130 (as depicted by spaces 113, 115) for effective sliding.

With continued reference to FIG. 1, frame 110 may comprise additional support members 150, 152 coupled to each of the leg members 112, 114. Support members 150, 152 provide additional support to frame 110, and may also serve as a connection point for spring-loaded mechanism 140. Spring-loaded mechanism 140 may attach to support member 150 and is operable to receive slide tube 132 when the gate 120 is drawn closed. In other words, when the gate 120 drops to a closed position, the spring mechanism 140 catches on a slide tube 132, and will secure the gate in a closed position. This mechanism prevents captured wild animals from lifting the gate and escaping if they root or dig around the trap door 100.

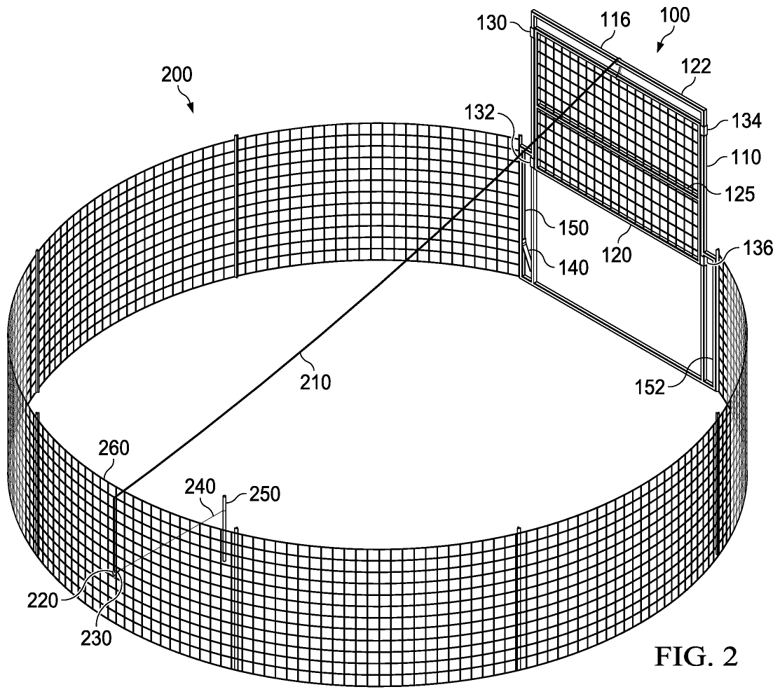

FIG. 2 illustrates the drop-style trap door of FIG. 1 used in connection with a corral-style trapping system 200. According to the present disclosure, trap door 100 may be held in an open position via rope 210 pulled to tension. One end of rope 210 may be tied to the top side 122 of the gate 120 and then wrapped one revolution around the connecting member 116 of frame 110. This configuration not only holds gate 120 in an open position, but also adds friction and maintains rope 210 in appropriate tension.

With continued reference to FIG. 2, the rope 210 is pulled across the perimeter of the trapping system 200 to back side 260, where the opposing end of rope 210 may be coupled to a snap shackle 220 or other such quick-release locking mechanism. According to an implementation, snap shackle 220 may be held in place by pin 230. The pin 230 may be coupled to a trip wire 240, which in turn may be coupled to a stake 250.

In operation, the user places animal feed inside the corral to draw wild animals inside the trapping system 200. Wire 240 may be camouflaged by pine or cedar branches so that it remains undetected by the animals. As more animals feed around the corral, they will inevitably trip the camouflaged wire 240. When wire 240 is tripped, pin 230 is released from snap shackle 220, thereby substantially eliminating the tension in rope 210. As the rope 210 is released, gate 120 drops from its open position to a closed position. Slide tube 132 engages spring-loaded mechanism 140, thereby securing the gate 120 in the closed position.

It is to be understood that the implementations are not limited to particular apparatus or methods described which may, of course, vary. For example, the drop-style trap door 100 need not be limited to the specific design or parts disclosed herein. Moreover, the invention defined by the above paragraphs is not to be limited to particular details set forth in the above description, as many apparent variations thereof are possible without departing from the spirit or scope of the present disclosure. It is also to be understood that the terminology used herein is for the purpose of describing particular implementations only and is not intended to be limiting.

1. A trap door for trapping an animal comprising:
an outer frame;
a gate positioned adjacent to the outer frame and having a plurality of slide tubes capable of vertically translating along the outer frame; and
a spring-loaded mechanism coupled to the outer frame for receiving at least one of the plurality of slide tubes and securing the gate in a closed position.

2. The trap door of claim 1, wherein the outer frame comprises:
two vertically parallel metal tubes connected at the top and bottom by horizontal metal tubes.

3. The trap door of claim 2, wherein the outer frame further comprises:
an additional leg member coupled to each of the two vertically parallel metal tubes for supporting the spring-loaded mechanism.

4. The trap door of claim 1, wherein the plurality of slide tubes are positioned on at least a top left, a top right, a bottom left, and a bottom right segment of the gate to substantially eliminate binding when the gate is drawn to a closed position.

5. A trap door for trapping an animal comprising:
an outer frame having parallel vertical sides;
a gate having a left side and a right side parallel to and adjacent to the parallel vertical sides of the outer frame, the left side and the right side each having a pair of slide tubes to facilitate vertical translation of the gate along the outer frame; and
a spring-loaded mechanism coupled to the outer frame for securing the gate in a closed position.

6. The trap door of claim 5, wherein the parallel vertical sides of the outer frame are connected at a top and bottom by horizontal metal tubes.

7. The trap door of claim 5, wherein the outer frame further comprises:
an additional leg member coupled to each of the parallel vertical sides for supporting the spring-loaded mechanism.

8. The trap door of claim 1, wherein each pair of slide tubes are spaced substantially apart along the left side and the right side of the gate.
